(19) United States
(12) Patent Application Publication
(10) Pub. No.: US 2009/0206109 A1
(43) Pub. Date: Aug. 20, 2009

(54) DEVICE FOR DISPENSING GAS-LIQUID MIXTURES

(75) Inventor: Stefano Santagiuliana, Caldogno VI (IT)

Correspondence Address: BIRCH STEWART KOLASCH & BIRCH, PO BOX 747, FALLS CHURCH, VA, 22040-0747, US

(73) Assignee: TAPLAST S.P.A., Dueville (IT)

(21) Appl. No.: 11/884,442

(22) PCT Filed: Feb. 22, 2006
(86) PCT No.: PCT/IB2006/000336

§ 371 Date: Sep. 22, 2008

(30) Foreign Application Priority Data
Feb. 25, 2005 (IT) VI2005A000053

(51) Int. Cl. B67D 5/58; B67D 5/56; B67D 5/60

(52) U.S. Cl. 222/190; 222/135; 222/145.6

(57) ABSTRACT

The invention concerns a device (1, 100, 101, 102, 103, 104, 105) for dispensing gas-liquid mixtures that can be associated with a container (C) of a liquid (L), comprising: suction means (2) suited to be moved from a first rest position to a second position in order to draw the liquid (L); a mixing chamber (3) communicating with the suction means (2), so that when the suction means are moved from the first position to the second position the liquid (L) is drawn and conveyed into the mixing chamber (3); compression means (5) for a gas (7). The compression means (5) comprise two chambers (5a, 5b) suited to contain the gas (7), communicating with the mixing chamber (3), so that when the suction means (2) are moved from the first to the second position part of the gas is conveyed into the mixing chamber (3).

The invention concerns a device for dispensing gas-liquid mixtures that can be associated with a container containing a liquid product to be dispensed in the form of foam or spray.

As already known, dispensing devices that are applied to the container of the product in question are widely used to dispense liquid or creamy products, like food substances, soaps, creams, detergents or perfumes, in the form of foam or spray.

These devices, which can be operated manually, take the product from the container and mix it with a pressurized gas, usually constituted by air, thus generating a foam or spray mixture during the dispensing phase.

They substantially comprise suction means that can be elastically moved from a first rest position to a second position and are suited to draw the product from the container and convey it towards a mixing chamber.

Said suction means substantially comprise a hollow body, defining a suction/compression chamber for the product, to which a piston can be slidingly coupled, wherein said piston can be moved between the above mentioned positions and operated by means of an actuator.

The device also comprises air compression means that can be operated in a coordinated way with the above mentioned suction means, to convey pressurized air taken from the environment towards the same mixing chamber.

Said compression means substantially comprise another hollow body, defining a gas compression chamber, to which another tight piston is slidingly coupled.

Valve means regulate the flow of the product and of the air from the two chambers to the mixing chamber during the various operating phases of the device.

Downstream of the mixing chamber and upstream of the device outlet there is a porous partition or a filter or a nozzle through which the air-product mixture is made flow to facilitate the formation of the foam or of the spray mixture.

Once the product has been dispensed, elastic means ensure the return of the piston to the rest position.

From an operating point of view, the user loads the elastic means via the actuator and at the same time compresses the product and the air contained in the corresponding chambers, thus allowing them to flow towards the mixing chamber.

The air and the product are thus mixed with each other and made flow through the porous partition or the nozzle the produces the desired foam or spray mixture. Then the user releases the actuator and allows the elastic means to bring the device back to its initial rest position.

The elastic return of the pistons generates a vacuum in the respective chambers, which determines the flow of the air and the product and prepares the device for the next time it will be used.

The quality of these devices depends on their capacity to produce, in the same conditions, a better foam or spray.

The quality of the foam and of the spray dispensed depends on the ratio of product to air mixed every time the device is operated.

The optimal ratio substantially depends on the characteristics of the product to be dispensed.

The devices described above should also have the smallest possible size. This is important in order to reduce the overall dimensions of the device-container unit as much as possible, to minimize the space required for storage and to maximize the quantity of product stored in the container.

A further drawback connected to the previous one is constituted by the fact that these dimensional limits reduce the quantity of product that can be dispensed every time the device is operated.

Another drawback of the known devices is constituted by the fact that the average product-aria ratio of the mixture dispensed every time the device is operated cannot be changed.

The aim of the present invention is to overcome all the drawbacks described.

In particular, one of the aims of the invention is to carry out a device for dispensing gas-liquid mixtures in the form of foam or spray that, with the same overall dimensions, dispenses a greater quantity of product than the devices of the known type.

It is a further aim of the invention to carry out a device that, with the same piston stroke, dispenses a greater quantity of product than the devices of the known type.

It is a further aim of the invention to carry out a device that dispenses a greater quantity of product than the devices of the known type, even if the force required to operate it, also called operating load, is the same.

It is another aim of the invention to carry out a device where it is possible to change the ratio of product to air dispensed every time the device is used.

It is another aim of the invention to carry out a device that also allows the user to select in advance a specific quantity of fluid to be dispensed.

It is another aim of the invention to produce a device that is more compact compared to the equivalent devices of the known type.

It is another aim of the invention to produce a dispensing device that allows the user to lock/release its operation.

It is a further aim of the invention to carry out a device that can be completely recycled, with no need to previously disassemble it or to carry out other operations.

It is another, yet not the least aim of the invention to carry out a device that is economical and easy to use, as well as easy to construct and to assemble and suitable for mass production.

The aims mentioned above have been achieved through the implementation of a device for dispensing gas-liquid mixtures that can be associated with a liquid container that, in accordance with the main claim, comprises:
suction means suited to be moved from at least a first rest position to at least a second position to draw said liquid;
at least one mixing chamber communicating with said suction means, so that when said suction means are moved from said at least one first position to said at least one second position, said liquid is drawn and conveyed into said at least one mixing chamber;
gas compression means;
   characterized in that said compression means comprise at least two chambers suited to contain said gas and communicating with said at least one mixing chamber, so that when said suction means are moved from said at least one first position to said at least one second position, at least a part of said gas is conveyed into said at least one mixing chamber.

Advantageous embodiments of the invention are described in the dependent claims.

The proposed solution advantageously makes it possible to carry out devices that dispense even twice the quantity of foam dispensed by the known devices, though having the same stroke and requiring the same effort to be operated.

Still to advantage, a solution proposed is provided with means suited to activate and/or select one or more of the above mentioned air chambers, thus allowing the product-air ratio and/or the quantity dispensed to be changed.

The aims and advantages described above will be highlighted in greater detail in the description of some preferred embodiments of the invention, provided indicatively as examples without limitation, with reference to the enclosed drawings, wherein:

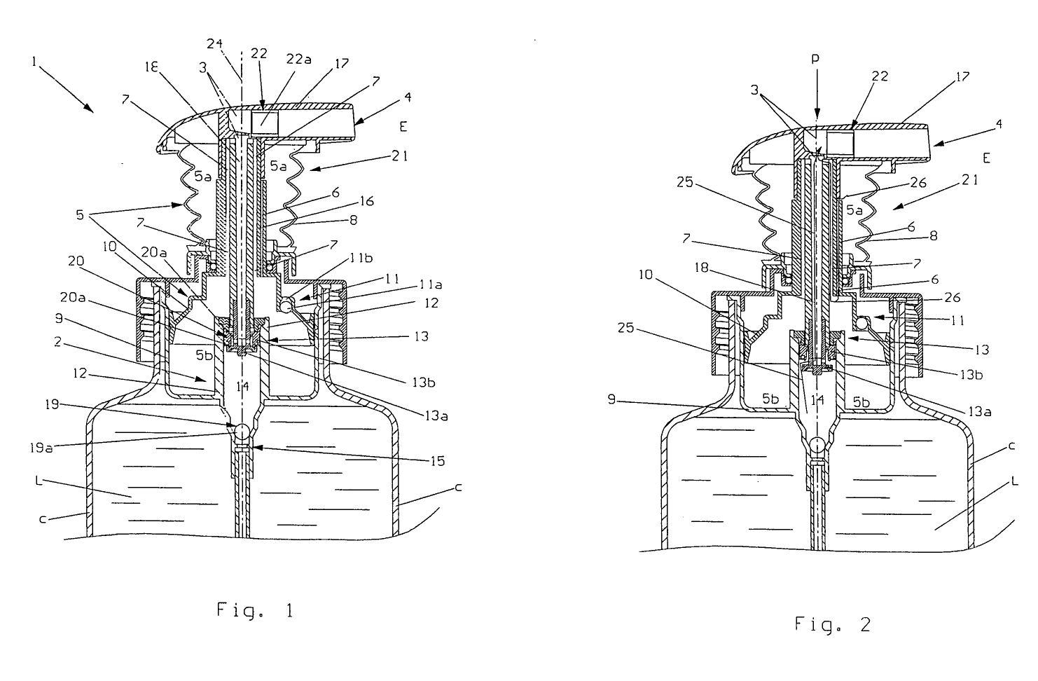

FIG. 1 shows a longitudinal cross section of an example of embodiment of a device carried out according to the invention;

each of FIGS. 2, 3 and 4 shows a longitudinal cross section of the device shown in FIG. 1, in the same number of operating phases;

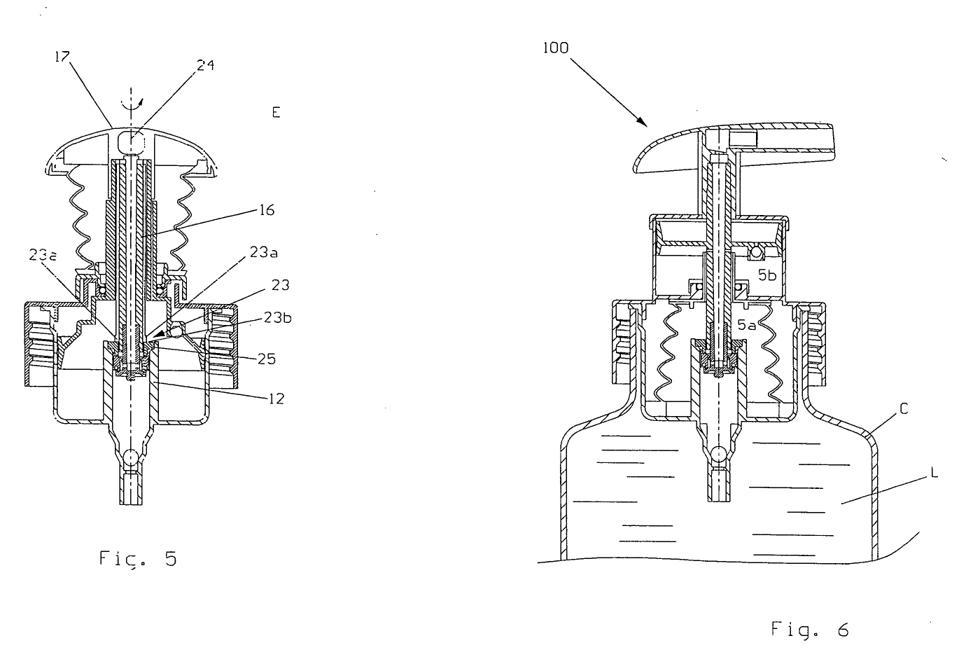

FIG. 5 shows a longitudinal section of the device shown in FIG. 1 in the locked position;

each of FIGS. 6, 7 and 8 shows a longitudinal cross section of the same number of examples of devices that implement the invention;

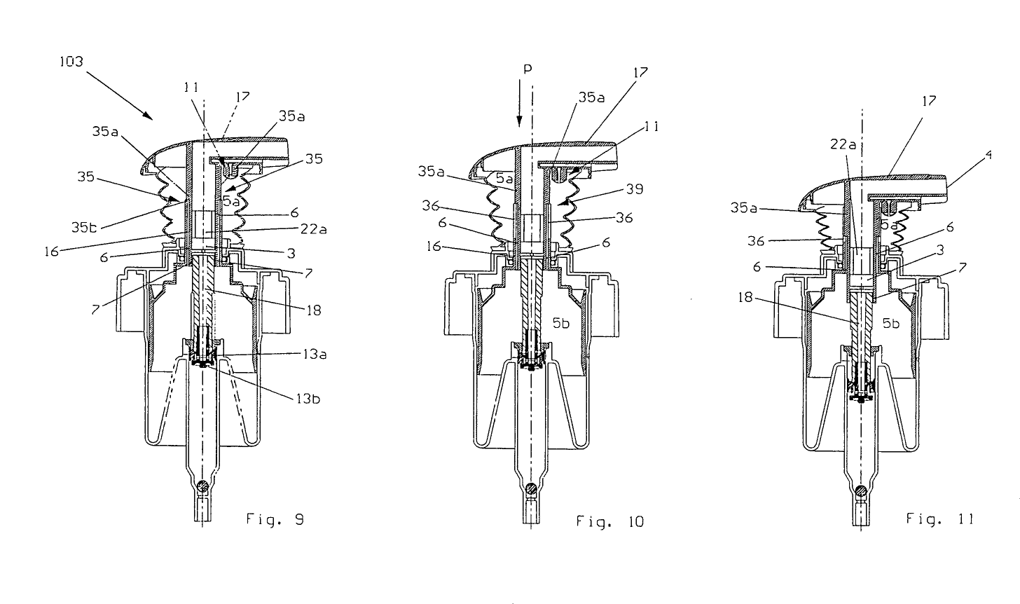

FIG. 9 shows a longitudinal cross section of a further embodiment of a device carried out according to the invention;

each of FIGS. 10 and 11 shows a longitudinal cross section of the device shown in FIG. 9, in the same number of operating positions;

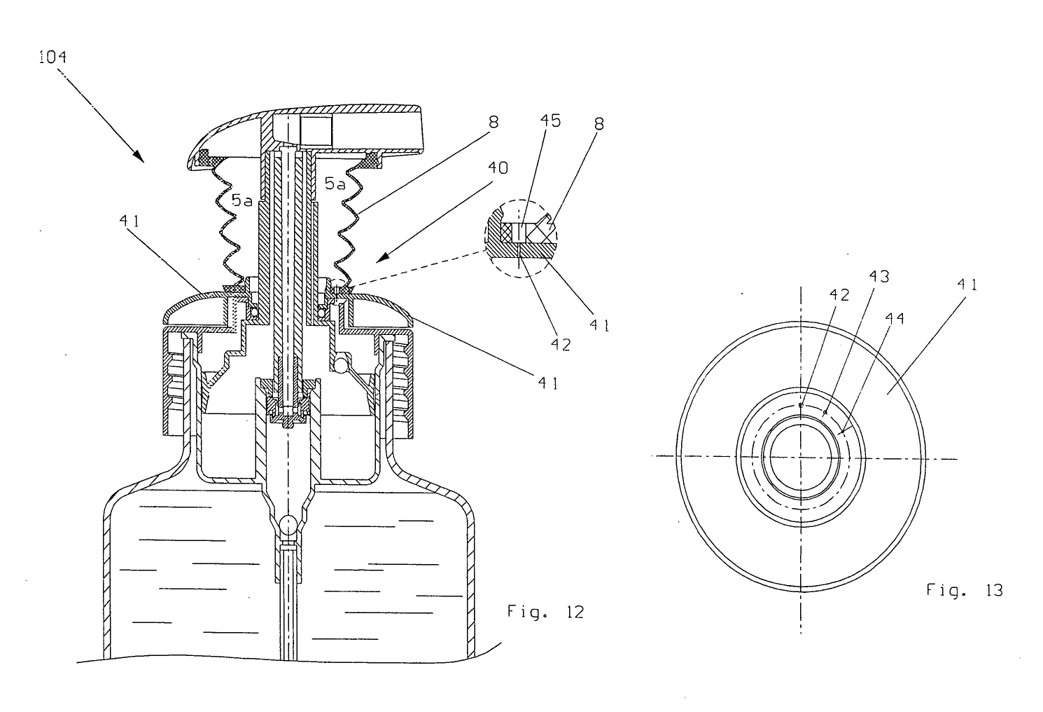

FIG. 12 shows a longitudinal cross section of a further example of embodiment of a device carried out according to the invention;

FIG. 13 is a plan view of an element of the device shown in FIG. 12;

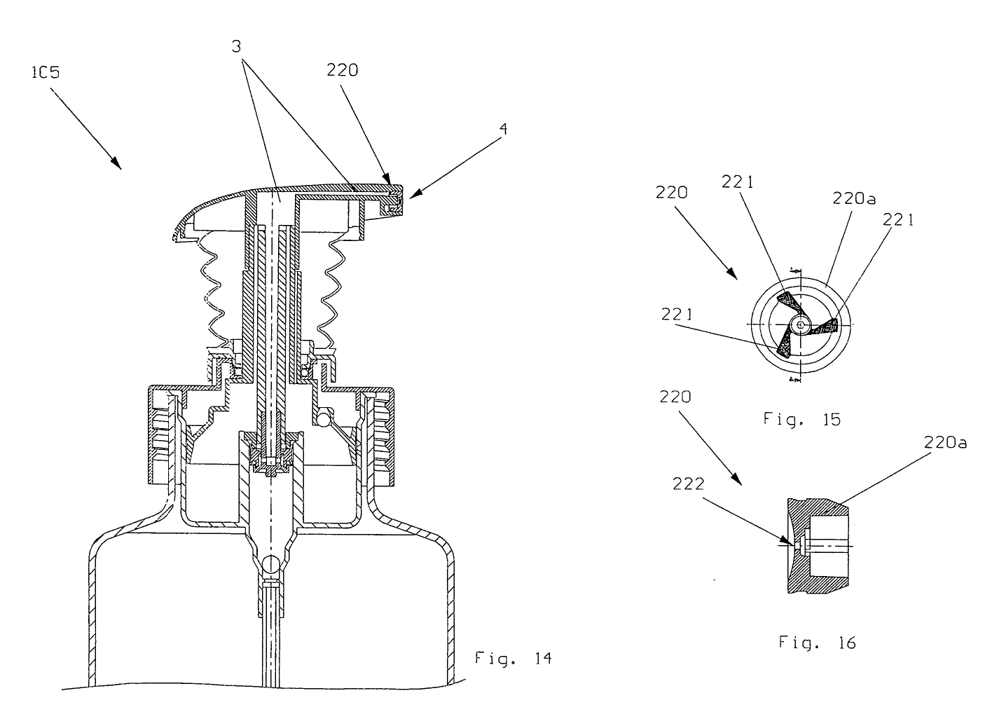

FIG. 14 shows a longitudinal cross section of a further embodiment of a device carried out according to the invention suited to dispense a product in the form of spray;

FIG. 15 is a plan view of an element of the device shown in FIG. 14;

FIG. 16 shows a cross section of the element of FIG. 15 according to plane A-A.

The examples of embodiment of the invention described below refer to devices for dispensing detergent liquids. It is clear that the solution proposed can be applied also to devices for dispensing perfumes or food products, or any other fluid in general that must be drawn from a container and conveyed towards the outside in the form of foam or spray.

An example of embodiment of a device for dispensing fluids, which is the subject of the present invention, applied to a container C containing a fluid L to be dispensed in the form of foam is shown in FIG. 1, where it is indicated as a whole by 1.

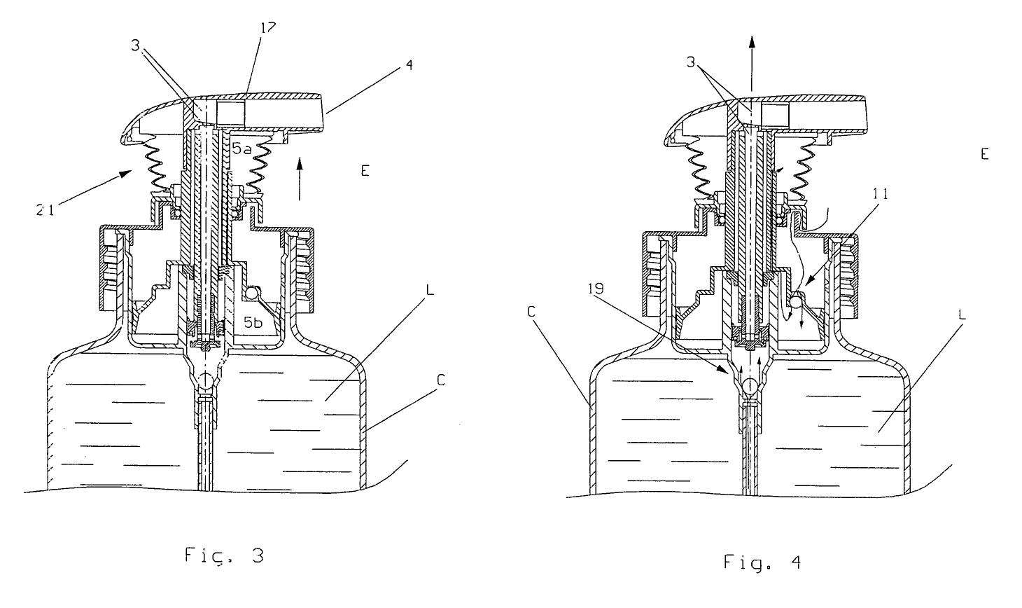

It comprises suction means 2 suited to be moved from a first rest position, shown in FIG. 1, to a second position, shown in FIG. 3, to draw from the container C the fluid L, constituted in this case by a detergent fluid, and convey it first towards a mixing chamber 3 and then towards the outlet 4 of the device 1.

The device 1 also comprises gas compression means 5, suited to convey the pressurized gas, constituted in this case by air, towards the mixing chamber 3.

According to the invention, said compression means 5 comprise two or more preferably independent chambers suited to contain the above mentioned gas and communicating with the mixing chamber 3, so that when the suction means 2 are moved from the first to the second position the gas is at the same time conveyed into the mixing chamber 3 to produce a foam.

This advantageously makes it possible to increase the quantity of pressurized air conveyed into the mixing chamber 3 every time the device is operated, with no need to change the stroke of the suction means 2.

In the embodiment of the invention shown the chambers are two, 5a and 5b, and communicate with each other via a communication duct 6 and with the mixing chamber 3 via an air conveying duct 7.

A first chamber 5a develops outside the volume defined by the container C and a second chamber 5b develops in its internal volume.

In particular, the first chamber 5a is constituted by a collapsible chamber defined by a bellows 8 and the second chamber 5b comprises a first hollow body 9 to which a first piston 10 is slidingly coupled.

First valve means 11 regulate the return of air in the two chambers 5a and 5b after each dispensing operation.

In the case in hand, said first valve means 11 comprise a ball 11a made of a non-metallic material, housed in a seat 11b.

As regards the suction means 2 of the liquid L, they comprise a second hollow body 12, which in this case constitutes a single body with the first hollow body 9, to which a second piston 13 is slidingly coupled.

The second hollow body 12 defines a suction/compression chamber 14 of the liquid L and is provided with a suction duct 15 of the liquid L.

A rod 16 connects the second piston 13 to an actuator 17, also called operating cap or button, by means of which the user operates the device 1.

Inside the rod 16 there is a conveying duct 18 for the liquid L, communicating with the suction/compression chamber 14 and with the mixing chamber 3.

As regards the second piston 13, it comprises a support element 13a to which a plunger 13b is slidingly coupled, said plunger 13b tightly cooperating with the walls of the suction/compression chamber 14.

Second and third valve means 19 and 20, located upstream and downstream of the suction duct 15 and of the conveying duct 18, respectively, regulate the flow of the liquid L from the container C to the suction/compression chamber 14 and its flow from the chamber 14 itself to the mixing chamber 3.

In the embodiment of the invention described, the second valve means 19 comprise a second ball 19a made of a non-metallic material, while the third valve means 20 comprise sealing edges 20a.

The device 1 also comprises elastic means, indicated as a whole by 21, suited to ensure that the suction means 2 return to the first position once the product has been dispensed.

In the embodiment of the invention shown herein said elastic means 21 are constituted by the same bellows 8 that defines the first chamber 5a and that in this case is elastic and made of a synthetic material.

Downstream of the mixing chamber 3 and upstream of the outlet 4 of the device 1 there are also means 22 suited to facilitate the production of foam and comprising, in said embodiment, a porous partition 22a.

The device 1 also comprises means suited to lock/release the device 1, indicated as a whole by 23 and visible in FIG. 6.

Said means 23 are suited to prevent or allow the operation of the device 1 and can be activated by selectively turning the actuator element 17 around a longitudinal axis 24 from a first predefined locking position A, shown in FIG. 5, to a second predefined operating position, shown in FIGS. 1, 2 and 3.

They comprise a first opposing element constituted by a first element 23a protruding from and integral with the rod 16, visible in FIG. 5, suited to selectively interfere with a second opposing element belonging to an annular body 25 and integral with the second hollow body 12.

In the case in question said second opposing element comprises a horizontal plane 23b that interferes with the element 23a, thus locking the axial movement of the plunger-rod-actuator unit. The horizontal opposing plane 23b is interrupted by a vertical groove, not shown, obtained on the annular element 25, on which the protruding element 23a can slide when operated by the user to allow the movement of the second piston 13 when the actuator element 17 is brought to the release position.

A first construction variant of the device subject of the invention, indicated as a whole by 100 in FIG. 6, is differentiated from the previous one due to the fact that the collapsible chamber 5a is positioned inside the volume defined by the container C and the cylindrical chamber 5b is positioned outside the container C.

A further construction variant, not shown for the sake of brevity, is differentiated from the previous ones due to the fact that both chambers are of the collapsible type.

A further construction variant not represented herein is differentiated from the previous one due to the fact that both chambers comprise a hollow body and a moving piston.

A different embodiment of the invention, not represented herein, is differentiated from the previous ones due to the fact that the two chambers do not communicate with each other and that each chamber is equipped with its own duct for conveying the pressurized gas.

A further embodiment of the invention indicated as a whole by 101 in FIG. 7 is differentiated from the previous one due to the fact that the elastic means 21 comprise a metal helical spring 30 housed in the suction/compression chamber 14 of the liquid L. More precisely, said helical spring 30 has one end opposing the support element 13a and the other end opposing the bottom wall of the chamber 14 itself.

It should also be observed that according to this embodiment the chamber 5b partly extends also outside the volume defined by the container C.

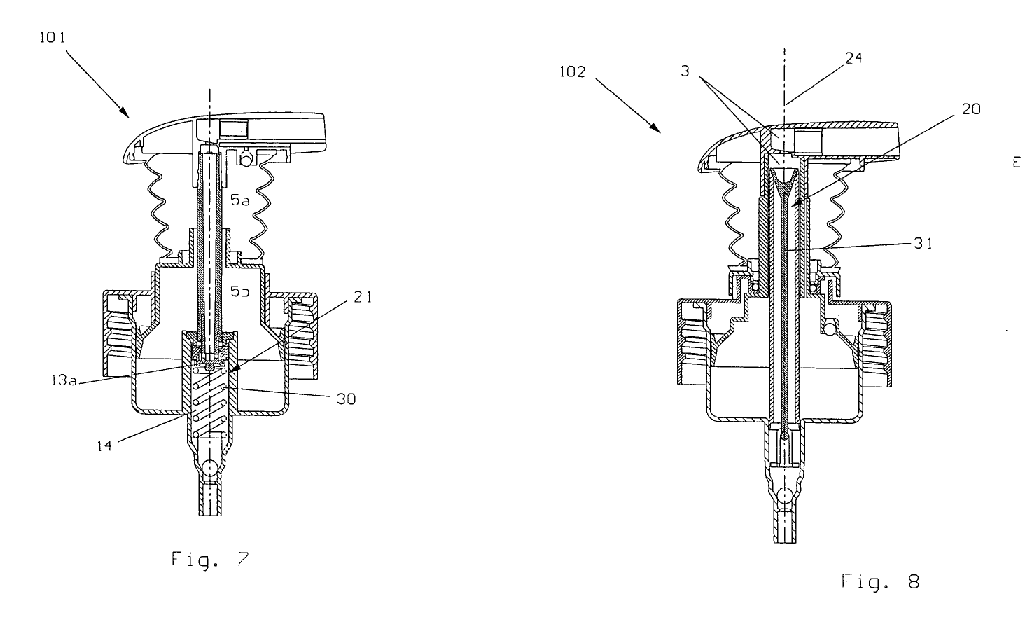

A further construction variant indicated as a whole by 102 in FIG. 8 is differentiated from the previous one due to the fact that the third valve means 20 comprise a shutter element 31 that can move along a longitudinal axis 24.

Another construction variant indicated as a whole by 103 in the FIGS. from 9 to 11 is differentiated from the previous ones due to the fact that the device 103 comprises activation/deactivation means 35 of one of the two air compression chambers 5a and 5b, thus making it possible to change the air-liquid ratio of the dispensed product every time the device is operated.

In the case in hand said means 35 comprise a first opposing element 35a suited to act against a second opposing element 35b or to be slidingly coupled to a groove 36, visible in FIG. 10, made in the rod 16 of the second piston.

In the embodiment shown, the first opposing element 35a comprises a rib integral with the stem of the actuator and the second opposing element 35b is constituted by the plane surface that defines the end of the rod of the first piston 10.

It should also be observed that the first valve means 11 comprise a valve of the so-called “umbrella” type.

Other solutions not represented herein are differentiated from the previous one due to the fact that the activation/deactivation means of the two chambers are carried out with valve elements that can be selectively activated and deactivated by the user to discharge the pressurized air, for example towards the outside. In this embodiment the device also comprises valve means that are positioned in the pressurized air conveying duct and can be activated/deactivated.

A further construction variant indicated as a whole by 104 in FIG. 12 is differentiated from the previous ones due to the fact that the device also comprises means for regulating the quantity and/or pressure of the air conveyed into the mixing chamber 3, indicated as a whole by 40.

Said means 40 thus make it possible to change the air-liquid ratio every time the device is operated and comprise a moving metal ring 41, shown in detail in FIG. 13, provided with holes with appropriate diameter 42, 43 and 44 suited to be selectively arranged at the level of at least one breather opening 45 with which at least one of the two chambers is provided. In the case in hand, the opening 45 is obtained at the level of the base of the elastic bellows 8 that defines the collapsible chamber 5a.

In this case the user, before operating the device 104, turns the metal ring 41 to close the opening 45 completely or partially, depending on the desired air-liquid ratio and/or on the type of foam desired, as properly indicated on the cap.

A further embodiment not represented herein is differentiated from the previous one due to the fact that the device also comprises means suited to change the allowed stroke of the suction means 2.

This advantageously allows the quantity of foam dispensed to be changed, at the same time maintaining a constant air-liquid ratio. Said means comprise an opposing element suited to be selectively coupled to grooves of different length made for example into a guide metal ring carried out in such a way as to be integral with the container.

In this case the user, before operating the device, first turns the actuator element 17 to the position corresponding to the quantity of liquid to be dispensed and properly indicated on the cap.

It is clear that all the valve means included in the device and described up to this point may be replaced with any equivalent valve of the known type, as well as the systems for locking/releasing and limiting the stroke of the suction means.

It is important to observe that the mixing chamber 3 substantially extends from the area where the two air and liquid conveying ducts meet at least until reaching the porous partition 22a.

A further embodiment of the invention indicated as a whole by 105 in FIG. 14 is differentiated from the previous ones due to the fact that the device dispenses the liquid product in the form of spray.

For this purpose, downstream of the mixing chamber 3 and upstream of the outlet 4 of the device 104 there are means 220 suited to facilitate the spraying of the product.

Said means 220 comprise, in the case in question, a nozzle 220a, represented in detail in FIGS. 15 and 16, provided with three ducts 221, shown in FIG. 15, that convey the air-product mixture towards the outlet 222 of the nozzle, thus causing a turbulence that leads to the spraying of the mixture.

The operation of the device subject of the invention will be now described with reference to the first embodiment represented in FIG. 1, since a comparison with the other devices represented in FIGS. 6, 7, 8 and 14 does not show any substantial differences.

From an operational point of view, the user first turns the actuator 17 in such a way as to set the device 1 to the desired operating mode.

More precisely, to lock the device 1 the user turns the spout or nozzle 17 around the axis 24 until it reaches the position shown in detail in FIG. 5. In this position the first opposing elements 23a face the horizontal plans 23b. This prevents any axial movement of the actuator-rod-plunger unit.

Vice versa, to operate the device 1 the user turns the actuator element 17 around the axis 24 until it reaches the position shown in FIGS. 1, 2, 3 and 4. In this position the first opposing elements 23a face the groove, along which they can slide freely, thus allowing the piston 13 and the compression means to move axially under the pressure P exerted by the user on the actuator 17.

In this way the user loads the elastic means 22 and compresses both the product L contained in the suction/compression chamber 3 and the air contained in the two chambers 5a and 5b, as shown in FIG. 2.

The pressure increase in the suction/compression chamber 14 makes the plunger 13b slide on the support element 13a, thus allowing the liquid L contained in the chamber 14 itself to flow first towards the liquid conveying duct 18 and then towards the mixing chamber 3, following the path indicated by 25 in FIG. 13.

At the same time and analogously, the pressure increase in the compression chambers 5a, 5b pushes the pressurized air first towards the air conveying duct 7 and then towards the mixing chamber 3, following the path indicated by 26.

The piston 13, once it has reached the bottom of the suction/compression chamber 14, as shown in FIG. 3, is released by the user, so that the elastic means 21 can bring it back to its initial rest position shown in FIG. 1.

The elastic return generates a vacuum inside the suction/compression chamber 14 and also inside the chambers 5a, 5b.

This vacuum causes the operation of the second and third valve means 19 and 20 and makes the liquid L flow into the suction/compression chamber 14, as shown in FIG. 4, thus preparing the device for the next time it will be used.

At the same time and analogously, the vacuum generated in the compression chambers causes the operation of the first valve means 11, which in this way allow the air to flow from the outside E into the chambers 5a, 5b, thus preparing the device 1 for the next time it will be used.

The operation of the device represented in FIGS. 9, 10 and 11 is differentiated from the previous one due to the fact that the user, before operating the device, must turn the actuator element 17 to the position corresponding to the desired air-liquid ratio indicated on the cap.

When the device 103 is set in such a way as to obtain the maximum quantity of air, the two opposing elements 35a and 35b interfere with each other and the operation of the device 103 is the same as described above.

Vice versa, when the device 103 is set in such a way as to obtain the minimum quantity of air, as represented in FIGS. 10 and 11, the first opposing element 35a is positioned at the level of the longitudinal groove 36, as shown in detail in FIGS. 10 and 11.

In this situation the pressure P exerted by the user on the actuator 17 is not transferred to the first piston 10. Thus during operation the first piston 10 remains still, as shown in FIG. 11, excluding in this way the second chamber 5b.

The above description clearly shows that the solution proposed allows the drawbacks described to be eliminated.

In particular, the solution proposed advantageously makes it possible to obtain, with the same stroke of the actuator element, a foam having a different and even selectable air-liquid ratio.

Still to advantage, the solution proposed allows said ratio to be changed, thus maintaining a constant operating load for the device, said load substantially depending, as well known, on the shortening of the elastic element during operation.

Advantageously and preferably, all the parts of the device proposed can be made also of a plastic or synthetic material. This makes it possible to obtain a device that can be completely recycled, with no need to previously separate the parts made of metallic materials or in any way of incompatible materials.

Even though the invention has been described with reference to the enclosed drawings, upon implementation certain modifications may be made, which are all included in the inventive concept expressed in the following claims and are therefore protected by the present patent.

1) Device (1, 100, 101, 102, 103, 104, 105) for dispensing gas-liquid mixtures that can be associated with a container (C) of a liquid (L), comprising:
suction means (2) suited to be moved from at least a first rest position to at least a second position to draw said liquid (L);
at least one mixing chamber (3) communicating with said suction means (2), so that when said suction means are moved from said at least one first position to said at least one second position, said liquid (L) is drawn and conveyed into said at least one mixing chamber (3);
gas (7) compression means (5);
characterized in that said compression means (5) comprise at least two chambers (5a, 5b) suited to contain said gas (7), communicating with said at least one mixing chamber (3) so that when said suction means (2) are moved from said at least one first position to said at least one second position, at least a part of said gas is conveyed into said at least one mixing chamber (3).

2) Device according to claim 1), characterized in that said at least two chambers communicate with each other through at least one communication duct and with said at least one mixing chamber through at least one gas conveying duct.

3) Device according to claim 2), characterized in that said at least one communication duct is provided with valve means suited to control the passage of said gas.

4) Device according to claim 1), characterized in that each one of said at least two chambers communicates with said at least one mixing chamber through at least one pressurized gas conveying duct.

5) Device according to claim 2), characterized in that said device further comprises valve means arranged in said at least one pressurized gas conveying duct.

6) Device according to claim 1), characterised in that said device further comprises activation/deactivation means of at least one of said at least two chambers, said means being suited to change the gas-liquid ratio of the product dispensed each time the device is operated.

7) Device according to claim 6), characterized in that said activation/deactivation means comprise at least a first opposing element suited to oppose at least a second opposing element or to be slidingly coupled to at least one groove.

8) Device according to claim 6), characterized in that said activation/deactivation means comprise valves that can be selectively activated and deactivated to unload the pressurized gas, for example towards the outside in order not to convey it towards said at least one mixing chamberorder td and deactivated to unload the pressurised gas, for example towards the outside in order tsed e.

9) Device according to claim 1), characterised in that said device further comprises valve means that regulate the return of said gas in said at least two chambers.

10) Device according to claim 9), characterized in that said valve means comprise a ball made of a non-metallic material, housed in a seat.

11) Device according to claim 1), characterized in that at least one of said at least two chambers comprises a collapsible chamber.

12) Device according to claim 11), characterized in that said collapsible chamber is defined at least partly by a bellows.

13) Device according to claim 1), characterised in that at least one of said at least two chambers comprises a first hollow body to which a first piston is slidingly coupled.

14) Device according to claim 1), characterized in that when said device is associated with said container at least one of said at least two chambers develops at least partially inside the volume defined by said container.

15) Device according to claim 1), characterized in that said liquid suction means comprise a second hollow body to which at least a second piston is slidingly coupled, said second hollow body defining at least one suction/compression chamber for said liquid and being provided with a duct for drawing said liquid.

16) Device according to claim 15), characterized in that said second piston is connected, via at least one rod, to at least one actuator element by means of which the user operates the device.

17) Device according to claim 16), characterized in that the inside of said rod is provided with at least one liquid conveying duct, communicating with said at least one suction/compression chamber and with said at least one mixing chamber.

18) Device according to claim 15), characterized in that said at least one second piston comprises a support element to which a plunger is slidingly coupled, said plunger tightly cooperating with the walls of said at least one suction/compression chamber.

19) Device according to claim 15), characterized in that said device further comprises second and third valve means suited to regulate the flow of said liquid from said container to said at least one suction/compression chamber and its flow towards said at least one mixing chamber.

20) Device according to claim 19), characterized in that said first and/or second valve means comprise a second ball and/or sealing edges.

21) Device according to claim 1), characterized in that said device further comprises elastic means suited to ensure, once the product has been dispensed, the return of said suction means and/or compression means to the first position.

22) Device according to claim 21), characterized in that said elastic means comprise at least one elastic bellows.

23) Device according to claim 21), characterized in that said elastic means comprise at least one helical spring.

24) Device according to claim 1), characterized in that said device further comprises means for locking/releasing said suction means and/or said compression means, said locking/releasing means being suited to prevent or allow the operation of said device.

25) Device according to claim 16), characterized in that said means for locking/releasing said suction means and/or said compression means can be activated by selectively rotating said actuator element.

26) Device according to claim 24), characterized in that said locking/releasing means comprise a first protruding element suited to selectively interfere with a second opposing element or to be slidingly coupled to at least one groove.

27) Device according to claim 1), characterized in that said device further comprises means suited to vary the quantity of gas-liquid mixture dispensed every time the device is operated.

28) Device according to claim 27), characterized in that said means suited to vary the quantity of mixture dispensed are suited to vary the stroke of said suction means and/or of said compression means.

29) Device according to claim 28), characterized in that said means suited to vary the quantity of mixture dispensed comprise an opposing element suited to be selectively coupled to grooves of different lengths made in a guide metal ring.

30) Device according to claim 1), characterized in that said device further comprises means to regulate the quantity and/or pressure of the gas conveyed into said at least one mixing chamber, and wherein said means can be selectively activated by the user.

31) Device according to claim 30), characterized in that said means for regulating the quantity and/or pressure of the gas conveyed into said at least one mixing chamber comprise a moving metal ring provided with one or more holes with appropriate diameter suited to be selectively arranged at the level of at least one opening present in at least one of said at least two chambers.

32) Device according to claim 1), characterized in that said device further comprises means suited to facilitate the formation of foam arranged downstream of said mixing chamber and upstream of an outlet of said device.

33) Device according to claim 32), characterized in that said means suited to facilitate the formation of foam comprise at least one porous partition and/or one filter.

34) Device (105) according to claim 1), characterized in that said device further comprises means suited to facilitate the spraying of said mixture arranged downstream of said mixing chamber and upstream of an outlet of said device.

35) Device according to claim 34), characterized in that said means suited to facilitate the spraying of said mixture comprise at least one nozzle.

36) Device according to claim 3), characterized in that said valve means are of the unidirectional type.

37) Device according to claim 36), characterized in that said valve means comprise one valve of the so-called “umbrella” type.

38) System for dispensing gas-liquid mixtures, preferably but not necessarily in the form of foam or spray, comprising a liquid container and a dispensing device, characterized in that said dispensing device is carried out according claim 1).
